(19) United States
(12) Patent Application Publication
(10) Pub. No.: US 2011/0047627 A1
(43) Pub. Date: Feb. 24, 2011

(54) METHOD AND SYSTEM FOR SECURE DATA EXFILTRATION FROM A CLOSED NETWORK OR SYSTEM

(75) Inventor: Victor I. Sheymov, Vienna, VA (US)

Correspondence Address: The Villamar Firm PLLC, 3424 Washington Drive, Falls Church, VA, 22041, US

(73) Assignee: INVICTA NETWORKS, INC., Reston, VA (US)

(21) Appl. No.: 12/921,615

(22) PCT Filed: Mar. 9, 2009
(86) PCT No.: PCT/US09/36454

§ 371 Date: Sep. 9, 2010

Related U.S. Application Data
(60) Provisional application No. 61/035,352, filed on Mar. 10, 2008.

(51) Int. Cl. G06F 15/16; G06F 12/14

(52) U.S. Cl. 726/26

(57) ABSTRACT

A method, system, and device for secure data exfiltration from a closed communications network or system, including at least one of means for data exfiltration from one or more of computers or computing devices of a closed communications network or system to one or more of computers or computing devices on another communications network or system; and means for internal or external secure data storage coupled to the exfiltration means and the other communications network or system and configured to receive the data for exfiltration based on control from the exfiltration means.

### CROSS REFERENCE TO RELATED DOCUMENTS

The present invention claims benefit of priority to U.S. Provisional Patent Application Ser. No. 61/035,352 of Sheymov, entitled “METHOD AND SYSTEM FOR SECURE DATA EXFILTRATION FROM A CLOSED NETWORK OR SYSTEM,” filed on Mar. 10, 2008, the entire disclosure of which is hereby incorporated by reference herein.

### BACKGROUND OF THE INVENTION

1. Field of the Invention

The present invention generally relates to systems and methods for secure communications, and more particularly to a system and method for secure data exfiltration from a closed communications network or system, such as a Systems Control And Data Acquisition (SCADA) system, an InvisiLAN system, and the like.

2. Discussion of the Background

In recent years, closed or secure systems and networks have found more and more real world applications. For example, a Systems Control And Data Acquisition (SCADA) system includes a closed or secure system and network used as a control and management solution in a wide range of critical industries, such as water management systems, gas and electric power distribution systems, traffic signaling systems, mass transit systems, environmental control systems, manufacturing systems, financial infrastructure systems, and the like. Similarly, an InvisiLAN system or network includes a closed system or network that employs Variable Cyber Coordinates (VCC) for a transmitter and receiver and which are not constant, but rather are constantly, and rapidly changing, wherein new coordinates are communicated only to authorized parties. The Cyber Coordinates can include any suitable address employed in any suitable communications system, such as a computer IP address or port, a telephone number, a Media Access Control (MAC) address, Ethernet Hardware Address (EHA), and the like.

Accordingly, the above systems can be used to create a more or less secure or closed network. However, often a need exists for some limited data to be transferred to another destination (e.g., an open or closed or secured or unsecured network, computer or computing device, etc.) outside such a closed or secure network or system. An example of this can include providing data to an open or unsecured accounting department network from a closed or secured SCADA system used for controlling gas distribution. Arranging such data exfiltration usually is difficult without compromising the security of the closed or secured network. Indeed, there is a contradiction is this example, because while the SCADA network needs to be secured and closed, the accounting network needs to be open and thus less secure, almost by definition. Accordingly, such a connection for transfer or exfiltration of data represents a degradation of security to the level of security of the least secure network, which in the example above is the accounting network.

### SUMMARY OF THE INVENTION

Therefore, there is a need for a method and system that address the above and other problems with data exfiltration from a closed communications network or system. The above and other needs are addressed by the exemplary embodiments of the present invention, which provide a novel method and system for secure data exfiltration from a closed communications network or system, such as a Systems Control And Data Acquisition (SCADA) system, an InvisiLAN system, and the like.

Accordingly, in exemplary aspects of the present invention, a method, system, and device for secure data exfiltration from a closed communications network or system are provided, including at least one of means for data exfiltration from one or more of computers or computing devices of a closed communications network or system to one or more of computers or computing devices on another communications network or system; and means for internal or external secure data storage coupled to the exfiltration means and the other communications network or system and configured to receive the data for exfiltration based on control from the exfiltration means.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary system for secure data exfiltration from a closed communications network or system; and

FIG. 2 illustrates another exemplary system for secure data exfiltration from a closed communications network or system.

### DETAILED DESCRIPTION OF THE PREFERRED EMBODIMENTS

The present invention includes recognition of the limited nature of a required connection between a closed and open network or system for secure data exfiltration. Accordingly, in an exemplary embodiment, the created communications link is appropriately limited so that, advantageously, the link cannot be used for anything else but secure data exfiltration. The exemplary embodiments can be applied to any suitable closed communications network or system, such as a Systems Control And Data Acquisition (SCADA) system, an InvisiLAN system, and the like. The InvisiLAN system is further described on the World Wide Web (e.g., at invictanetworks.com). However, the teachings of the exemplary embodiments are applicable to other types of networks or systems where there is a need for secure data exfiltration, as will be appreciated by those skilled in the relevant art(s).

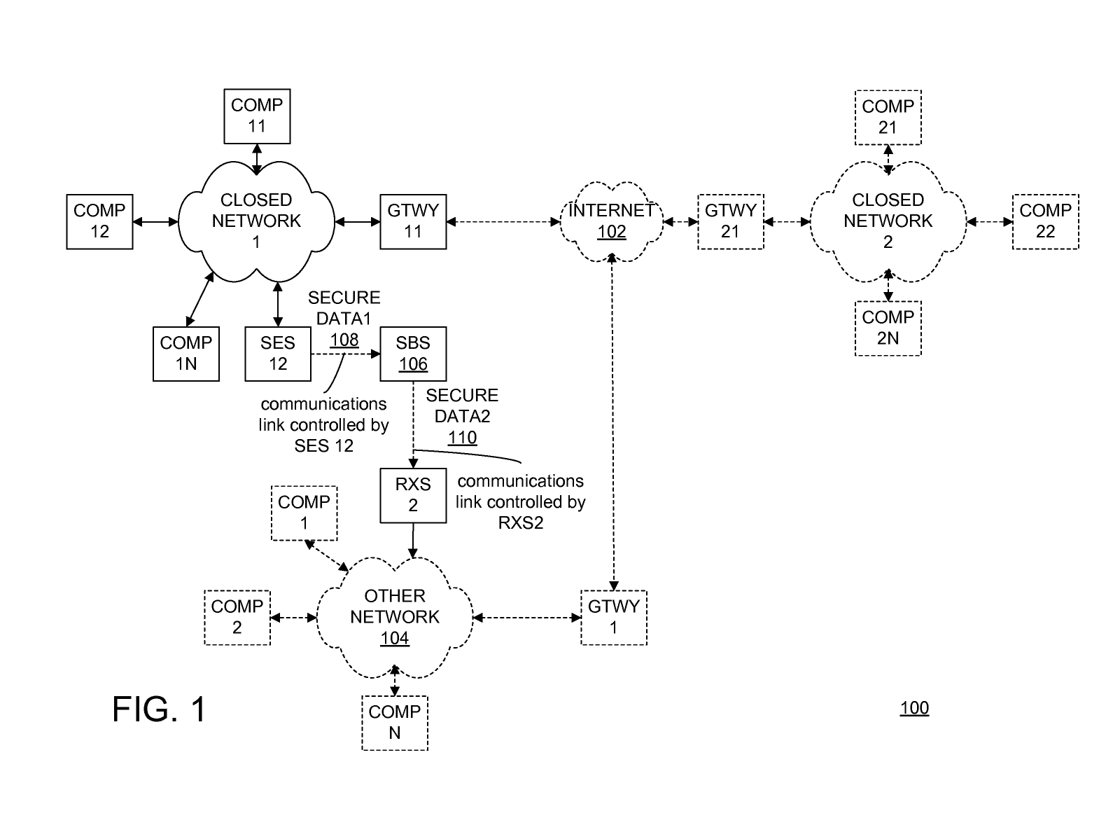

Referring now to the drawings, FIG. 1 thereof illustrates an exemplary system 100 for secure data exfiltration from a closed communications network or system and for addressing the above and other problems with secure communications. In FIG. 1, closed communications network or system 1 includes one or more computers or computing devices (COMP) 11, 12 . . . 1N and can also include a gateway (GTWY) 11 (e.g., a router, a computer, etc.) for providing communication over an unsecured network 102, such as the Internet, with closed communications network or system 2. Similarly, the closed communications network or system 2 includes one or more computers or computing devices 21, 22 . . . 2N and gateway 21 (e.g., a router, a computer, etc.) for providing communication over the unsecured network 102, such as the Internet, with closed communications network or system 1. Examples of the systems 1 and 2 can include any suitable closed communications networks or systems, such as Systems Control And Data Acquisition (SCADA) systems, InvisiLAN systems, and the like.

As shown in FIG. 1, another communications network or system 104 includes one or more computers or computing devices 1, 2 . . . N and gateway 1 (e.g., a router, a computer, etc.) for providing unsecured communication over the unsecured network 102, such as the Internet. Examples of the other communications network or system 104 can include any suitable open or closed or secured or unsecured communications network, system, computer, computing device, and the like, such as accounting department networks or systems, Internet networks or systems, and the like.

According to the exemplary embodiments, data for exfiltration, for example, is located on and is to be transferred from one or more of the computers or computing devices 11, 12 . . . 1N on the closed communications network or system 1 to one or more of the computers or computing devices 1, 2 . . . N on the other communications network or system 104. For this purpose, a secure exfiltration server (SES) 12 (e.g., a secure server, a secure computer, a secure computing device, etc.) is provided on or securely accessed by the closed communications network or system 1 for coupling, for example, to an internal or external secure buffer server 106 (SBS, e.g., a secure memory device or system, such as a secure hard drive, secure database, secure tape backup system, secure server, secure computing device, etc.) and for transferring the secure data 108 (SECURE DATA1) for exfiltration from the closed communications network or system 1 to the other communications network or system 104.

Accordingly, the data 108 destined for exfiltration (e.g., secure data) is dumped from the closed communications network or system 1 to the secure buffer server 106. One or more restrictions can be applied to the secure data connection between the closed communications network or system 1 and the secure buffer server 106, including time restrictions, protocol restrictions, one-way transmission restrictions, applicable (e.g., usable) commands restrictions, and the like. After the data dump is complete for a data exfiltration cycle, the secure data 108 connection between the closed communications network or system 1 and the secure buffer server 106 can be closed via the secure exfiltration server 12, for example, until the next data dump.

On the other communications network or system 104 side, a receiving server (RXS) 2 (e.g., a secure or un-secure computer, a secure or un-secure computing device, etc.) is provided, and which also is connected to the secure buffer server 106 for receiving the secure data 110 (SECURE DATA2) for storage, transmission, or further processing. Similarly, one or more restrictions can be applied to the data 110 connection between the other communications network or system 104 and the secure buffer server 106, including time restrictions, protocol restrictions, one-way receipt restrictions, applicable (e.g., usable) commands restrictions, and the like. After the data receipt is complete for a data receipt cycle, the data connection between the other communications network or system 104 and the secure buffer server 106 can be closed via the receiving server 2, for example, until the next data receipt.

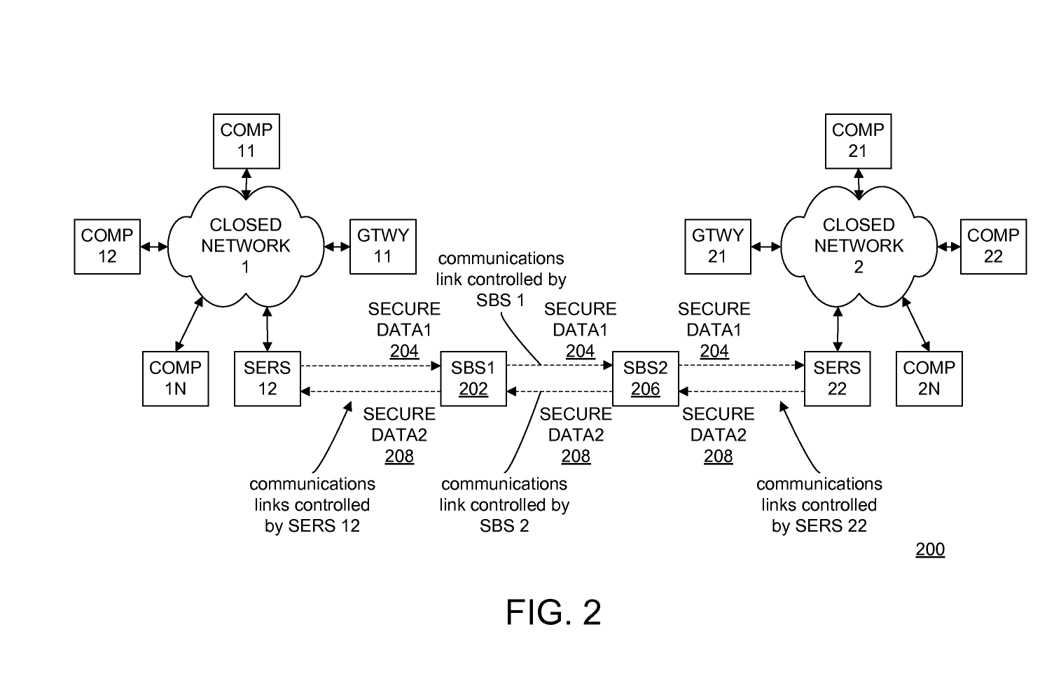

FIG. 2 illustrates another exemplary system 200 for secure data exfiltration from a closed communications network or system. In FIG. 2, the closed communications network or system 1 communicates with the closed communications network or system 2. Examples of the systems 1 and 2 can include Government entities, countries, organizations, corporations, and the like, that may not wish to be under the control of a single closed communications network or system, such as via the secure exfiltration server 12 of the closed communications network or system 1 of FIG. 1. Accordingly, a first external or internal secure buffer server 202 (SBS1, e.g., a secure memory device or system, such as a secure hard drive, secure database, secure tape backup system, secure server, secure computing device, etc.) is provided for transferring first secure data 204 (SECURE DATA1) for exfiltration via a secure exfiltration/receiving server (SERS) 12 (e.g., a secure server, a secure computer, a secure computing device, etc.) from the closed communications network or system 1 to the closed communications network or system 2. Similarly, a second external or internal secure buffer server 206 (SBS2, e.g., a secure memory device or system, such as a secure hard drive, secure database, secure tape backup system, secure server, secure computing device, etc.) is provided for transferring second secure data 208 (SECURE DATA2) for exfiltration from the closed communications network or system 2 to the closed communications network or system 1 via a secure exfiltration/receiving server 22 (e.g., a secure server, a secure computer, a secure computing device, etc.) of the closed communications network or system 2. The secure exfiltration/receiving servers 12 and 22 are connected to the respective secure buffer servers 202 and 206 for receiving the respective secure data 204 and 208 (SECURE DATA1, and SECURE DATA2) for storage, transmission, or further processing.

As with the system of FIG. 1, one or more respective restrictions can be applied to the respective secure data 204 and 208 connections (SECURE DATA1, and SECURE DATA2) between the closed communications network or system 1 and the first secure storage device 202 (SBS1), and between the closed communications network or system 2 and the second secure storage device 206 (SBS2), including time restrictions, protocol restrictions, one-way transfer restrictions, applicable (e.g., usable) commands restrictions, and the like. After the data transfer is complete for a data receipt or data exfiltration cycle, the data 204 connection(s) between the closed communications network or system 1 and the first secure buffer server 202 and/or the data 208 connection(s) between the closed communications network or system 2 and the second secure buffer server 206 can be closed via the respective secure exfiltration/receiving servers 12 and 22, for example, until the next data receipt/transfer cycle.

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other electronic devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

1-5. (canceled)

6. A system for secure data exfiltration from a closed communications network or system, the system comprising:
an exfiltration device configured for data exfiltration from one or more of computers or computing devices of a closed communications network or system to one or more of computers or computing devices on another communications network or system; and
an internal or external secure data storage device coupled to the exfiltration device and the other communications network or system and configured to receive the data for exfiltration based on control from the exfiltration device.

7. A method for secure data exfiltration from a closed communications network or system, the method comprising:
exfiltration of data by an exfiltration device from one or more of computers or computing devices of a closed communications network or system to one or more of computers or computing devices on another communications network or system; and
receiving the data for exfiltration based on control from the exfiltration device by an internal or external secure data storage device coupled to the exfiltration device and the other communications network or system.

8. A computer program product for secure data exfiltration from a closed communications network or system, and including one or more computer readable instructions embedded on a computer readable medium and configured to cause one or more computer processors to perform the steps of:
exfiltration of data by an exfiltration device from one or more of computers or computing devices of a closed communications network or system to one or more of computers or computing devices on another communications network or system; and
receiving the data for exfiltration based on control from the exfiltration device by an internal or external secure data storage device coupled to the exfiltration device and the other communications network or system.
